(19) United States
(12) Patent Application Publication
(10) Pub. No.: US 2026/0168380 A1
(43) Pub. Date: Jun. 18, 2026

(54) METHOD FOR RELIABILITY ASSESSMENT OF SHIELD TUNNEL STRUCTURE BASED ON JOINT SAFETY RESERVE

(71) Applicant: Tongji University, Shanghai (CN)

(72) Inventors: Dongmei Zhang, Shanghai (CN); Zhongkai Huang, Shanghai (CN); Wending Zhou, Shanghai (CN); Xiaochuang Xie, Shanghai (CN); Yiyao Shen, Shanghai (CN)

(21) Appl. No.: 19/414,138

(22) Filed: Dec. 9, 2025

(30) Foreign Application Priority Data
Dec. 13, 2024 (CN) 202411841622.7

(51) Int. Cl. E21F 17/18; E21D 23/03; G01M 5/00

(52) U.S. Cl. CPC E21F 17/18; E21D 23/03; G01M 5/0041

(57) ABSTRACT

A method for reliability assessment of a shield tunnel structure based on joint safety reserve includes: acquiring relevant geological survey data and tunnel design documentation for a tunnel to be evaluated; selecting several shield tunnel joint cross-sections, and determining parameters for a calculation cross-section and internal forces of a shield tunnel structural joint under different burial depths; constructing an ultimate bearing capacity curve for a shield tunnel joint cross-section at different burial depths and locations based on a stress state of the joint; and calculating a joint reliability coefficient Kⱼ from the ultimate bearing capacity curve, and evaluating shield tunnel reliability using the joint reliability coefficient Kⱼ. By calculating the joint reliability coefficient Kⱼ for several cross-sections, reliability of the shield tunnel structural joint at different burial depths and locations can be analyzed, providing a novel approach for reliability assessment and real-time early warning of shield tunnel structures.

### CROSS-REFERENCE TO RELATED APPLICATION

This application claims priority of Chinese Patent Application No. 202411841622.7, filed on Dec. 13, 2024, the entire contents of which are incorporated herein by reference.

### TECHNICAL FIELD

The present disclosure relates to the technical field of shield tunnel reliability assessment, and particularly to a method for reliability assessment of a shield tunnel structure based on joint safety reserve.

### BACKGROUND

With the vigorous development of urban rail transit, an increasing number of cities are adopting shield tunnels constructed by assembling precast concrete segments as the primary structural form for urban rail transit systems. Monitoring of shield tunnels during operation has revealed that structural defects, such as lateral convergence deformation, segment joint opening and misalignment, joint water leakage, and segment damage, are seriously threatening tunnel structural safety. Consequently, the reliability assessment of operational tunnel structures is receiving increasingly widespread attention and emphasis. Currently, the reliability assessment of shield tunnel structures is mostly conducted by analyzing two aspects: a serviceability limit state and an ultimate limit state. Based on a review of recent research by scholars, commonly used reliability assessment indicators for shield tunnel structures primarily include the following categories: bearing capacity indicators, structural deformation indicators, durability indicators, and other indicators such as impermeability pressure.

Due to the ease of measuring tunnel deformation, existing methods for reliability assessment of shield tunnel structures primarily focus on deformation indicators, whereas research on reliability assessment based on bearing capacities of lining structures remains limited. From a structural perspective, safety issues in tunnel structures only arise when the applied load exceeds the material's bearing capacity. Therefore, the bearing capacity of the tunnel structure is the most critical indicator for evaluating its reliability, while structural deformation is merely a manifestation. Considering a distinct feature of shield tunnels, namely the presence of numerous joints between segments where the actual stiffness is lower than that of the segments themselves, making these joints weak points in the structural load-bearing capacity, the present disclosure provides a method for definition and calculation of the joint reliability coefficient Kⱼ based on safety reserve. Consequently, a method for reliability assessment of a shield tunnel structure based on safety reserve is developed, providing a novel approach for reliability assessment and real-time early warning of shield tunnel structures.

### SUMMARY

In the present disclosure, a method for reliability assessment of a shield tunnel structure based on joint safety reserve is established. By considering a configuration and safety reserve of a shield tunnel joint, the present disclosure provides a method for definition and calculation of a shield tunnel joint reliability coefficient Kⱼ. In this method, reliability analysis is performed on each joint cross-section by calculating a safety reserve status of the tunnel structural joint at different burial depths, cross-sections, and locations, thereby providing a novel approach for reliability assessment and real-time early warning of shield tunnel structures.

The present disclosure employs the following technical solution:
a method for reliability assessment of a shield tunnel structure based on joint safety includes the steps of:
S1, acquiring relevant geological survey data and tunnel design documentation for a tunnel to be evaluated;
S2, selecting several shield tunnel joint cross-sections, and determining parameters for a calculation cross-section and internal forces of a shield tunnel structural joint under different burial depths;
S3, constructing an ultimate bearing capacity curve for a shield tunnel joint cross-section at different burial depths and locations based on a stress state of the joint, with the curve calculated through Formula (1):

$${M}_{ju} = \{ \begin{matrix}{A}_{1} {N}_{ju}^{2} + {B}_{1} {N}_{ju} + {C}_{1} & {N}_{ju} \leq {N}_{ju 1} \\ {A}_{2} {N}_{ju}^{2} + {B}_{2} {N}_{ju} + {C}_{2} & {N}_{ju} > {N}_{ju 1}\end{matrix} \qquad Formula ( 1 )$$

where A₁, A₂, B₁, B₂, C₁, and C₂ are coefficients determined according to “Code for Design of Concrete Structures”; and Nⱼᵤ represents an axial compression acting on a segment joint, Mⱼᵤ denotes a bending moment capacity of the joint cross-section, and Nⱼᵤ₁ is a demarcation value distinguishing between different ultimate bearing states of the joint; and
S4, calculating a joint reliability coefficient Kⱼ from the ultimate bearing capacity curve, with the joint reliability coefficient Kⱼ derived from a ratio of a minimum distance between an actual joint internal force point and the ultimate bearing capacity curve of the joint to a distance between the actual joint internal force point and a coordinate origin; and evaluating shield tunnel reliability using the joint reliability coefficient Kⱼ.

The coefficients A₁, A₂, B₁, B₂, C₁, and C₂ in Formula (1) are obtained from Formula (2):

$$\{ \begin{matrix}{A}_{1} = - \frac{1}{2 {α}_{1} {f}_{c} w} \\ {B}_{1} = {h}_{e} - \frac{{f}_{by} {A}_{b}}{{α}_{1} {f}_{c} w} \\ {C}_{1} = {h}_{e} {f}_{by} {A}_{b} - \frac{{( {f}_{by} {A}_{b} )}^{2}}{2 {α}_{1} {f}_{c} w} \\ {A}_{2} = - \frac{{α}_{1} {f}_{c} {wm}_{1}^{2}}{2} \\ {B}_{2} = {α}_{1} {f}_{c} {wm}_{1} ( {h}_{e} - {m}_{2} ) \\ {C}_{2} = {α}_{1} {f}_{c} {wm}_{2} ( {h}_{e} - \frac{{m}_{2}}{2} ) \\ {m}_{1} = \frac{( {ξ}_{b} - {β}_{1} ) {h}_{e}}{{α}_{1} {f}_{c} w ( {ξ}_{b} - {β}_{1} ) {h}_{e} - ( {f}_{by} - {σ}_{b0} ) {A}_{b}} \\ {m}_{2} = - {m}_{1} ( \frac{{f}_{by} - {σ}_{b0}}{{ξ}_{b} - {β}_{1}} {β}_{1} {A}_{b} - {σ}_{b0} {A}_{b} )\end{matrix} \qquad Formula ( 2 )$$

where α₁ is a coefficient, whose value is determined with reference to the “Code for Design of Concrete Structures”; β₁ is a neutral axis height coefficient when a compressive zone height of a rectangular stress block is determined according to plane-section assumption; f_{c} is a design value of axial compressive strength of concrete; w is a width of the joint cross-section; h is a height of the joint cross-section; hₑ is an effective height of the joint cross-section; ξ_{b} is a relative depth of a balanced compression zone; f_{by} is a design value of tensile strength of prestressed tendons; σ_{b0} is an initial bolt pre-tightening force; and A_{b} is a corresponding bolt cross-sectional area.

In step S2, the internal forces of the shield tunnel structural joint under different burial depths are calculated using an elastic equation method.

The tunnel structural joint reliability coefficient Kⱼ is calculated by Formula (3):

$${K}_{j} = \frac{\vert {AA}^{′} \vert + \vert OA \vert}{\vert OA \vert} \qquad Formula ( 3 )$$

where |AA′| is the minimum distance between the actual joint internal force point A (Mⱼ, Nⱼ) and the ultimate bearing capacity curve of the joint, and |OA| is the distance between the internal force calculation point A and the coordinate origin.

The present disclosure has the following beneficial effects. In the present disclosure, a method for reliability assessment of a shield tunnel structure is established. In the future, by calculating the joint reliability coefficient Kⱼ for several cross-sections, reliability of the shield tunnel structural joint at different burial depths and locations can be analyzed, providing a novel approach for reliability assessment and real-time early warning of shield tunnel structures. Compared with other analytical methods, the present disclosure possesses the following distinctive features.
(1) The present disclosure provides a joint reliability coefficient Kⱼ based on safety reserve, which broadens an indicator system for shield tunnel reliability assessment.
(2) The present disclosure employs a reliability evaluation indicator based on bearing capacity, which can reflect tunnel structure reliability more directly compared to deformation-based indicators.
(3) An application of the present disclosure can effectively account for the safety reserve of the shield tunnel joint at different burial depths, cross-sections, and locations, which is of great significance for reliability assessment and real-time early warning of shield tunnel structures.

### BRIEF DESCRIPTION OF THE DRAWINGS

FIG. 1 shows a flow diagram of a method for reliability assessment of a shield tunnel structure based on joint safety reserve according to the present disclosure.

FIG. 2 shows an ultimate bearing capacity curve for a shield tunnel joint cross-section at different burial depths and locations.

FIG. 3 shows a schematic diagram of the ultimate bearing capacity curve and calculation of a reliability coefficient for a joint in a case study.

### DETAILED DESCRIPTION

The technical solutions in the embodiments of the present disclosure are further described clearly and completely below in combination with the accompanying drawings. Obviously, the embodiments are only some, rather than all embodiments of the present disclosure. Based on the embodiments of the present disclosure, all other embodiments obtained by those of ordinary skill in the art without creative efforts belong to the scope of protection of the present disclosure.

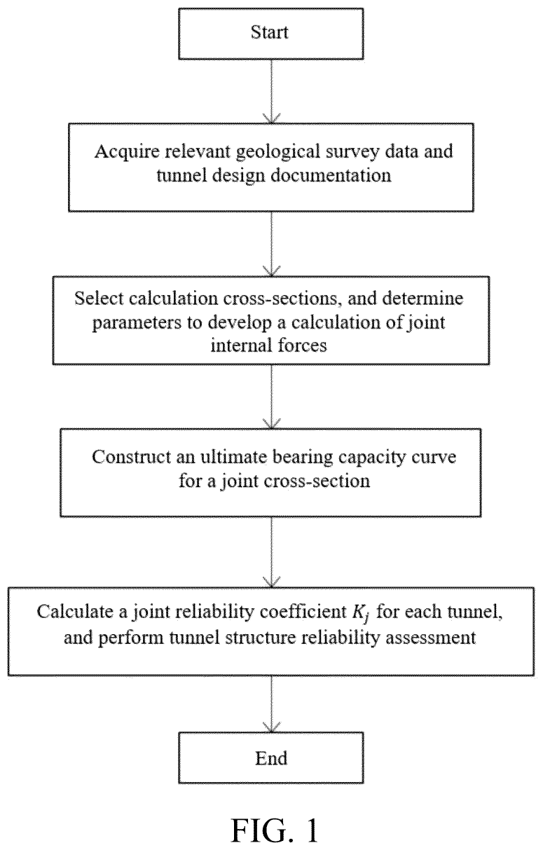

Referring to FIG. 1, a method for reliability assessment of a shield tunnel structure based on joint safety includes the following steps:

In S1, relevant geological survey data and tunnel design documentation are acquired for a tunnel to be evaluated.

In S2, several shield tunnel joint cross-sections are selected, parameters for a calculation cross-section are determined, and internal forces of a shield tunnel structural joint under different burial depths are calculated using an elastic equation method.

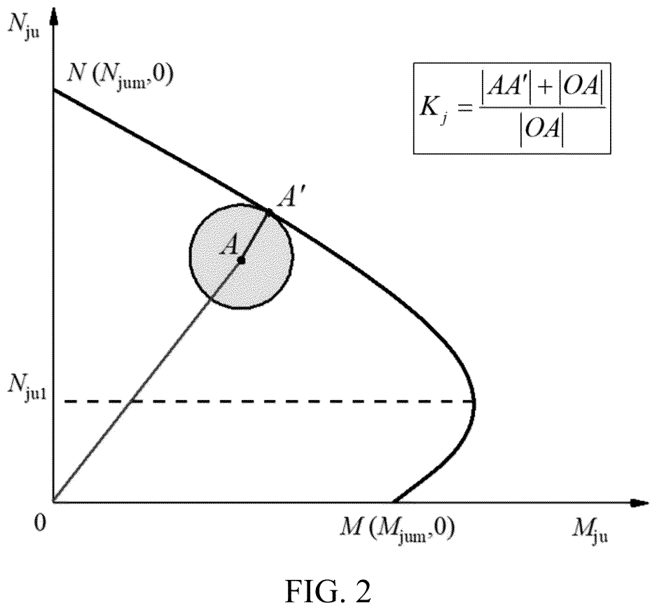

In S3, an ultimate bearing capacity curve for a shield tunnel joint cross-section at different burial depths and locations is constructed based on a stress state of the joint, as shown in FIG. 2. The aforementioned curve represents a bending moment capacity Mⱼᵤ of a segment joint cross-section under different axial compressive forces Nⱼᵤ. A method for calculating this curve is given by Formula (1):

$${M}_{ju} = \{ \begin{matrix}{A}_{1} {N}_{ju}^{2} + {B}_{1} {N}_{ju} + {C}_{1} & {N}_{ju} \leq {N}_{ju 1} \\ {A}_{2} {N}_{ju}^{2} + {B}_{2} {N}_{ju} + {C}_{2} & {N}_{ju} > {N}_{ju 1}\end{matrix} \qquad Formula ( 1 )$$

where A₁, A₂, B₁, B₂, C₁, and C₂ are coefficients, Nⱼᵤ represents an axial force on the joint cross-section, and Nⱼᵤ₁ is a demarcation value distinguishing between different ultimate bearing states of the joint. When Nⱼᵤ>Nⱼᵤ₁, the joint cross-section is in ultimate bearing state 1; and when Nⱼᵤ≤Nⱼᵤ₁, it is in ultimate bearing state 2. Methods for calculating each coefficient are given by Formula (2):

$$\{ \begin{matrix}{A}_{1} = - \frac{1}{2 {α}_{1} {f}_{c} w} \\ {B}_{1} = {h}_{e} - \frac{{f}_{by} {A}_{b}}{{α}_{1} {f}_{c} w} \\ {C}_{1} = {h}_{e} {f}_{by} {A}_{b} - \frac{{( {f}_{by} {A}_{b} )}^{2}}{2 {α}_{1} {f}_{c} w} \\ {A}_{2} = - \frac{{α}_{1} {f}_{c} {wm}_{1}^{2}}{2} \\ {B}_{2} = {α}_{1} {f}_{c} {wm}_{1} ( {h}_{e} - {m}_{2} ) \\ {C}_{2} = {α}_{1} {f}_{c} {wm}_{2} ( {h}_{e} - \frac{{m}_{2}}{2} ) \\ {m}_{1} = \frac{( {ξ}_{b} - {β}_{1} ) {h}_{e}}{{α}_{1} {f}_{c} w ( {ξ}_{b} - {β}_{1} ) {h}_{e} - ( {f}_{by} - {σ}_{b0} ) {A}_{b}} \\ {m}_{2} = - {m}_{1} ( \frac{{f}_{by} - {σ}_{b0}}{{ξ}_{b} - {β}_{1}} {β}_{1} {A}_{b} - {σ}_{b0} {A}_{b} )\end{matrix} \qquad Formula ( 2 )$$

where α₁ is a coefficient, whose value is determined with reference to “Code for Design of Concrete Structures”; β₁ is a neutral axis height coefficient when a compressive zone height of a rectangular stress block is determined according to plane-section assumption, and its specific value is taken from the relevant concrete design code; f_{c} is a design value of axial compressive strength of concrete; w is a width of the joint cross-section; h is a height of the joint cross-section; hₑ is an effective height of the joint cross-section; ξ_{b} is a relative depth of a balanced compression zone; pre-tightened bolts are considered equivalent to prestressed tendons, and a design value of tensile strength for the prestressed tendons, denoted as f_{by}, is adopted as a design tensile strength value of the bolts in joint bearing capacity calculations; σ_{b0} is an initial bolt pre-tightening force; and A_{b} is a corresponding bolt cross-sectional area.

In S4, a joint reliability coefficient Kⱼ is calculated from the ultimate bearing capacity curve. Based on the joint reliability coefficient Kⱼ, the reliability of each joint cross-section is evaluated and analyzed, thereby determining the safety status of the tunnel structure. Referring to FIG. 2, the tunnel structural joint reliability coefficient Kⱼ is calculated by Formula (3):

$${K}_{j} = \frac{\vert {AA}^{′} \vert + \vert OA \vert}{\vert OA \vert} \qquad Formula ( 3 )$$

where |AA′| is the minimum distance between the actual joint internal force point A (Mⱼ, Nⱼ) and the ultimate bearing capacity curve of the joint, which can be considered as a safety reserve for bearing capacity; and |OA| is the distance between the internal force calculation point A and the coordinate origin.

### Embodiment 1

A tunnel section in a certain area is selected for safety assessment. Geological survey data and tunnel design documentation are acquired. Three cross-sections are selected for safety evaluation. The parameters for each calculation cross-section are presented in Table 1 and Table 2, and design conditions of the calculation cross-section are calculated (taking calculation section 1 as an example). A summary of geometric and stratum parameters is as follows:
Segment inner diameter: Dᵢ=5500 mm
Segment outer diameter: D₀=6200 mm
Radius to centroid of segment: R_{c}=2925 mm
Elastic modulus of segment: E_{c}=3.55×10⁷ kPa
Unit weight of concrete segment: γ_{c}=26 kN·m⁻³
Cross-sectional area: A=bh=1×0.35=0.35 m²
Moment of inertia of cross-section: I_{c}=bh3/12=3.573×10⁻³ m⁻⁴
Flexural rigidity E_{c}I_{c}=1.268×10⁵ kN·m²
Subgrade reaction coefficient k=6000 kN·m⁻³
Joint stiffness coefficient: η=0.7
Joint bending moment transfer coefficient: ζ=0.4

TABLE 1
Parameters of the selected calculation cross-section

| | Center | Ground | Top burial |
|---|---|---|---|
| Cross-section No. | elevation (m) | elevation (m) | depth (m) |
| 1 | −17.05 | 1.05 | 15 |
| 2 | −18.05 | 2.05 | 17 |
| 3 | −20.05 | 3.05 | 20 |

TABLE 2
Physical and mechanical parameters of
soil at calculation cross-section 1

| | | | | | Peak shear | |
|---|---|---|---|---|---|---|
| | | | Soil | Coefficient | strength | |
| Soil | Soil | Thick- | weight | of earth | (consolidated | |
| layer | layer | ness | (kN · | pressure at | undrained) | |
| No. | name | (m) | m⁻³) | rest, K₀ | c/kPa | φ/° |
| (1)₁ | Artificial | 4.30 | 18 | 0.30 | 4 | 8 |
| | fill | | | | | |
| (2)₃ | Silty clay | 4.00 | 18.3 | 0.40 | 7 | 27 |
| (4)₁ | Clayey | 8.70 | 16.9 | 0.65 | 13 | 11 |
| | silt | | | | | |
| (5)₁₋₁ | Grey clay | 7.00 | 17.7 | 0.55 | 16 | 13 |

The internal forces of the lining structure are calculated based on the plane strain assumption, taking a 1-meter-long lining ring along the tunnel longitudinal direction for analysis. Using the elastic equation method, the internal forces of the lining structure are computed by superimposing the cross-sectional internal forces M, N, and V resulting from each applied load. The calculation results are summarized in Table 3.

TABLE 3
Calculation results of cross-section internal forces

| Burial | | Bending | Axial | |
|---|---|---|---|---|
| depth | Cross-section | moment Mⱼ | force Nⱼ | Eccentricity |
| H (m) | position | (kN · m) | (kN) | e₀ (m) |
| 15 | Top joint (8°) | 117.98 | 632.14 | 0.187 |
| | Waist joint (73°) | −98.30 | 835.94 | −0.118 |
| | Bottom joint (138°) | 35.53 | 767.55 | 0.046 |
| 17 | Top joint (8°) | 137.20 | 710.98 | 0.193 |
| | Waist joint (73°) | −112.25 | 942.88 | −0.119 |
| | Bottom joint (138°) | 42.07 | 858.79 | 0.049 |
| 20 | Top joint (8°) | 166.41 | 829.01 | 0.201 |
| | Waist joint (73°) | −133.23 | 1103.22 | −0.121 |
| | Bottom joint (138°) | 51.61 | 995.63 | 0.052 |

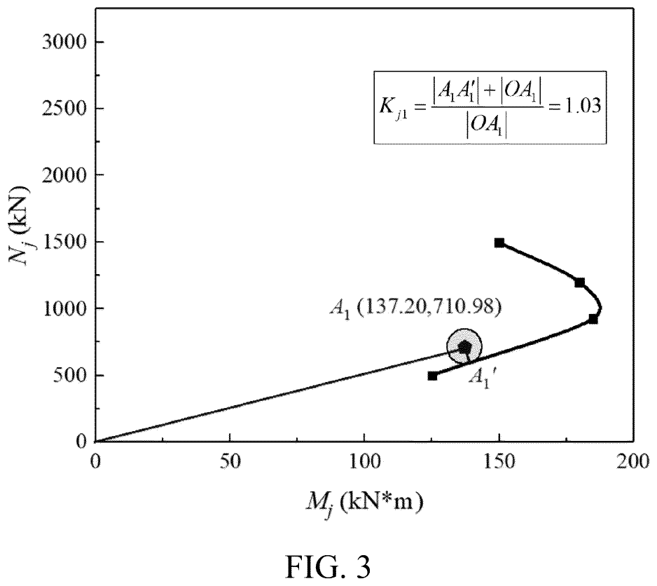

Substituting the data above into Formula (1) and Formula (2), the ultimate bearing capacity curve for the shield tunnel joint cross-section at different burial depths and locations is constructed based on the stress states, as shown in FIG. 3.

Subsequently, the joint reliability coefficient K₁ is calculated using Formula (3). The results are presented in Table 4.

TABLE 4
Joint reliability coefficient Kⱼ for different burial depths and locations

| Burial | | Bending | Axial | | Reliability |
|---|---|---|---|---|---|
| depth H | Cross-section | moment Mⱼ | force Nⱼ | | coefficient |
| (m) | position | (kN · m) | (kN) | \|AA′\| | Kⱼ |
| 15 | Top joint (8°) | 117.98 | 632.14 | 29.69 | 1.05 |
| | Waist joint (73°) | −98.30 | 835.94 | 73.26 | 1.09 |
| | Bottom joint (138°) | 35.53 | 767.55 | 129.41 | 1.17 |
| 17 | Top joint (8°) | 137.20 | 710.98 | 21.83 | 1.03 |
| | Waist joint (73°) | −112.25 | 942.88 | 65.34 | 1.07 |
| | Bottom joint (138°) | 42.07 | 858.79 | 127.13 | 1.13 |
| 20 | Top joint (8°) | 166.41 | 829.01 | 4.83 | 1.01 |
| | Waist joint (73°) | −133.23 | 1103.22 | 44.48 | 1.04 |
| | Bottom joint (138°) | 51.61 | 995.63 | 127.13 | 1.13 |

Based on the calculation results above, for a given lining type, the smaller the tunnel burial depth, the higher the joint reliability coefficient, and consequently, the safer the tunnel structure. The lining type in this case study is not recommended for subway tunnels with burial depths exceeding 20 m. Under the same burial depth, the reliability coefficients vary significantly across different joint positions. Specifically, within the same calculation cross-section, the joint reliability coefficient follows the trend: bottom joint>waist joint>top joint. Therefore, in scenarios such as ground surcharge, the top joint, which has the smallest safety reserve, needs to be given priority consideration as a key research focus.

Obviously, for those of skill in the art, the present disclosure is not limited to the details of the above exemplary embodiments, and the present disclosure may be realized in other specific forms, without departing from the spirit or essential feature of the present disclosure. Therefore, from any perspective, the embodiments are regarded as exemplary and non-restrictive.

1. A method for reliability assessment of a shield tunnel structure based on joint safety reserve, comprising the steps of:
S1, acquiring relevant geological survey data and tunnel design documentation for a tunnel to be evaluated;
S2, selecting several shield tunnel joint cross-sections, and determining parameters for a calculation cross-section and internal forces of a shield tunnel structural joint under different burial depths;
S3, constructing an ultimate bearing capacity curve for a shield tunnel joint cross-section at different burial depths and locations based on a stress state of the joint, with the curve calculated through Formula (1):
$${M}_{ju} = \{ \begin{matrix}{A}_{1} {N}_{ju}^{2} + {B}_{1} {N}_{ju} + {C}_{1} & {N}_{ju} \leq {N}_{ju 1} \\ {A}_{2} {N}_{ju}^{2} + {B}_{2} {N}_{ju} + {C}_{2} & {N}_{ju} > {N}_{ju 1}\end{matrix} \qquad Formula ( 1 )$$
where A₁, A₂, B₁, B₂, C₁, and C₂ are coefficients determined according to “Code for Design of Concrete Structures”; and Nⱼᵤ represents an axial compression acting on a segment joint, Mⱼᵤ denotes a bending moment capacity of the joint cross-section, and Nⱼᵤ₁ is a demarcation value distinguishing between different ultimate bearing states of the joint; and
S4, calculating a joint reliability coefficient Kⱼ from the ultimate bearing capacity curve, with the joint reliability coefficient Kⱼ derived from a ratio of a minimum distance between an actual joint internal force point and the ultimate bearing capacity curve of the joint to a distance between the actual joint internal force point and a coordinate origin; and evaluating shield tunnel reliability using the joint reliability coefficient Kⱼ; wherein
the coefficients A₁, A₂, B₁, B₂, C₁, and C₂ in Formula (1) are obtained from Formula (2):
$$\{ \begin{matrix}{A}_{1} = - \frac{1}{2 {α}_{1} {f}_{c} w} \\ {B}_{1} = {h}_{e} - \frac{{f}_{by} {A}_{b}}{{α}_{1} {f}_{c} w} \\ {C}_{1} = {h}_{e} {f}_{by} {A}_{b} - \frac{{( {f}_{by} {A}_{b} )}^{2}}{2 {α}_{1} {f}_{c} w} \\ {A}_{2} = - \frac{{α}_{1} {f}_{c} {wm}_{1}^{2}}{2} \\ {B}_{2} = {α}_{1} {f}_{c} {wm}_{1} ( {h}_{e} - {m}_{2} ) \\ {C}_{2} = {α}_{1} {f}_{c} {wm}_{2} ( {h}_{e} - \frac{{m}_{2}}{2} ) \\ {m}_{1} = \frac{( {ξ}_{b} - {β}_{1} ) {h}_{e}}{{α}_{1} {f}_{c} w ( {ξ}_{b} - {β}_{1} ) {h}_{e} - ( {f}_{by} - {σ}_{b0} ) {A}_{b}} \\ {m}_{2} = - {m}_{1} ( \frac{{f}_{by} - {σ}_{b0}}{{ξ}_{b} - {β}_{1}} {β}_{1} {A}_{b} - {σ}_{b0} {A}_{b} )\end{matrix} \qquad Formula ( 2 )$$
where α₁ is a coefficient, whose value is determined with reference to the “Code for Design of Concrete Structures”; β₁ is a neutral axis height coefficient when a compressive zone height of a rectangular stress block is determined according to plane-section assumption; f_{c} is a design value of axial compressive strength of concrete; w is a width of the joint cross-section; h is a height of the joint cross-section; hₑ is an effective height of the joint cross-section; ξ_{b} is a relative depth of a balanced compression zone; f_{by} is a design value of tensile strength of prestressed tendons; σ_{b0} is an initial bolt pre-tightening force; and A_{b} is a corresponding bolt cross-sectional area; and
the tunnel structural joint reliability coefficient Kⱼ is calculated by Formula (3):
$${K}_{j} = \frac{\vert {AA}^{′} \vert + \vert OA \vert}{\vert OA \vert} \qquad Formula ( 3 )$$
where |AA′| is the minimum distance between the actual joint internal force point A (Mⱼ, Nⱼ) and the ultimate bearing capacity curve of the joint, and |OA| is the distance between the internal force calculation point A and the coordinate origin.

2. The method for reliability assessment of a shield tunnel structure based on joint safety reserve according to claim 1, wherein in step S2, the internal forces of the shield tunnel structural joint under different burial depths are calculated using an elastic equation method.
